(19) United States
(12) Patent Application Publication
(10) Pub. No.: US 2019/0191222 A1
(43) Pub. Date: Jun. 20, 2019

(54) METHOD AND SYSTEM OF CONTENT DISTRIBUTION IN THE DATA TRANSFER NETWORK WITH BUILT-IN MECHANISM OF CONDITIONAL ACCESS

(71) Applicant: TELEPORT GLOBAL AG, Zug (CH)

(72) Inventor: Alexei Konstantinovich KLIMENKO, Perm (RU)

(73) Assignee: TELEPORT GLOBAL AG, Zug (CH)

(21) Appl. No.: 16/311,438

(22) PCT Filed: Jun. 19, 2017
(86) PCT No.: PCT/RU2017/050050

§ 371 Date: Dec. 19, 2018

(30) Foreign Application Priority Data
Jun. 20, 2016 (RU) 2016124322

(51) Int. Cl. H04N 21/6334; H04N 21/2343; H04N 21/8352; H04N 21/239; H04N 21/266; H04N 21/438; H04N 21/462; H04N 21/63

(52) U.S. Cl. CPC H04N 21/63345; H04N 21/23439; H04N 21/8352; H04N 21/632; H04N 21/26613; H04N 21/438; H04N 21/4622; H04N 21/2393

(57) ABSTRACT

The invention relates to the field of information technologies and communication and solves the task of video content delivery to the users in the data transfer network. The claimed method for the media content distribution in the data transfer network comprises: dividing the source file of the content into segments; creating a set of possible presentations for each of the segments; receiving a request from the user device for the content provision; creating, in response to the said request of the user device content, the downloading pointer is created, which comprises information on the content segments which are subject to provision to the said user device; transferring the said downloading pointer to the user device; on the user device side receiving the said downloading pointer; implementing a search is for at least one source comprising at least one segment of the content according to the received downloading pointer and communication session is initiated with the said at least one source; receiving at least one content segment in case of successful communication session; implementing received segment key match check.

### FIELD OF THE INVENTION

The invention relates to the field of information technologies and communication and solves the task of video content delivery to the users in the peer-to-peer and data transfer networks.

### BACKGROUND OF THE INVENTION

Currently, there are embodiments for distribution of content in peer-to-peer networks both for static (movie, melody, audio book etc.) and dynamic (streaming video, live TV or sports broadcasts etc.) content. All of them, generally, implement the following approach:

content (file) is divided into segments;

clients (software installed on the users PCs) establish connections directly with one another;

clients exchange file segments with one another ensuring availability of all the source file segments at each other.

It is obvious that with such solution the content, in the end, received by each client is strictly the same for all the clients.

For distribution of static content in P2P network bittorrent protocol is applied (http://www.bittorrent.org/beps/bep_0003.html). This protocol is open and there are a lot of its implementations in various programming languages (C/C++, java etc.) and for various platforms (Windows, Linux etc.)

For distribution of dynamic content in P2P network bittorrent live protocol is applied (U.S. Pat. No. 9,094,263 B2 patent, 28, Jul. 2015), as well as such services as peer5.com and streamroot.com, which use the WebRTC open library (https://ru.wikipedia.org/wiki/WebRTC).

Generally, these embodiments successfully solve the task of files delivery to the users in P2P network, however, from the point of view of copyright holders publishing the content on the data transfer network, such as Internet, it is necessary that every client receive a unique copy of the file which would comprise digital identifier, for example, digital watermark (tag) identifying the client and his/her legal right for the reception of the required content. In this instance, in case of unauthorized file distribution, it would be possible to trace the source of leakage—specific user who committed illegal content distribution.

However, simultaneous use of the described peer-to-peer technologies and digital watermarks is mutually exclusive due to the fact that for peer-to-peer exchange the content shall be strictly the same, while for digital watermarks—different for each receiver.

There are also known technologies on the market which combine the capabilities of both peer-to-peer technologies and watermarks. For example, according to the U.S. Pat. No. 7,570,641 B2 patent (Techniques for watermarking and distributing content, 4, Aug. 2009), system construction is possible which simultaneously use both peer-to-peer exchange and watermarks through distribution of content in parts and formation of unique sequence of parts for each user which is represented in the delivery plan presented to each client from the server.

However, this invention does not describe the specific mechanisms of creation and distribution of delivery plan which would ensure the impossibility of its substitution by a infringer that does not allow to achieve high level of security during content distribution in the data transfer network.

Thus, in the prior art, the embodiments present on the market are either not intended for the solution of the task of distribution channel protection, but focus on the solution of the task of distributed file delivery, or describe the mechanism of combination and simultaneous use of capabilities of peer-to-peer exchange and channel protection against illegal content distribution through watermarks and delivery plan, but does not describe the specific method for creation and distribution of delivery plan which would be substitution resistant.

### SUMMARY

The object of this invention is the creation of a new high-efficient technology of content distribution in the data transfer network, as well as in P2P, with built-in mechanism of conditional access based on the checking of keys distributed from the server.

The main technical result is the improvement of protection against illegal content distribution in the data transfer network through content transfer in parts based on the provision of content segments according to the downloading pointer which has increased resistance to substitution due to the segments keys use as the links to the segments, as well as the fact of the said keys checking during exchange of the content segments.

The additional technical results achieved in case of implementation of the claimed invention are the decrease of load on the server transfer channel through content distribution in parts (segments) and initiation of content segments exchange process between users which is capable of ensuring of reception by the user of 100% of content from the P2P without request to the server for the content, as well as increase of the content protection level against illegal distribution through the possibility of specific users detection who commit unauthorized copying and distribution of content based on the unique identifier, integrated in each copy of the content, connected with the user device.

In a preferred embodiment of the claimed invention a method for the media content distribution in the data transfer network is claimed, wherein:

on the server side:

the source file of the content is divided into segments, wherein a serial number is assigned to each segment;

a set of possible presentations is created for each of the segments by way of creation of at least one copy of each segment, and integrating of a digital identifier into each of the copies;

request is received from the user device for the content provision;

in response to the said request of the user device, the content downloading pointer is created, which comprises information on the content segments which are subject to provision to the said user device, wherein for each segment serial number one of this segment presentation alterations is chosen, wherein the downloading pointer comprises information on each content segment in the form of the segment key, such that the segment key is a function of the code information, comprising at least the information connected with the segment contents;

the said downloading pointer is transferred to the user device;

the information on the addresses of the sources comprising segments of the requested content is transferred to the said user device;

on the user device side:

the said downloading pointer is received;

search is implemented for at least one source comprising at least one segment of the content according to the received downloading pointer, and communication session is initiated with the said at least one source, wherein requests are sent for the downloading of segments by way of sending the keys of the required segments, wherein in the process of the said requests processing the check of match is implemented of the keys sent in the request with the segment keys stored in the source device;

at least one content segment is received in case of successful communication session and keys match, otherwise the search step is repeated for at least one source device;

received segment key match check is implemented by way of key generation from the code information connected with the contents of the received segment and its comparison with the key sent in the request.

In a particular embodiment, if one or more content segments can not be received from the source devices, the reception of the said content segments is implemented from the server.

In another particular embodiment the code information comprises the information connected with the segment contents and additional information.

In another particular embodiment the additional information is the identified of the user device which the content is for.

In another particular embodiment the digital identifier comprised in the segment represents a digital watermark.

In another particular embodiment data transfer in the P2P and data transfer network is implemented in encrypted form, as well as content segments are stored on the devices in encrypted form.

In another particular embodiment information from the users devices is transferred to the server on the content segments which it stores and can send to the other users devices via P2P, as well as information which segments have been downloaded from the P2P and which from the server.

In the second preferred embodiment of the claimed invention, the System of media content distribution in the data transfer network comprising at least one server and many users devices, wherein

the server is configured to execute operations, wherein:

the source file of the content is divided into segments, wherein a serial number is assigned to each segment;

a set of possible presentations is created for each of the segments by way of creation of at least one copy of each segment, and integrating of a digital identifier into each of the copies;

request is received from the user device for the content provision;

in response to the said request of the user device content, the downloading pointer is created, which comprises information on the content segments which are subject to provision to the said user device, wherein for each segment serial number one of this segment presentation alterations is chosen, wherein the downloading pointer comprises information on each content segment in the form of the segment key, such that the segment key is a function of the code information, comprising at least the information connected with the segment contents;

the said downloading pointer is transferred to the user device;

the information on the addresses of the sources comprising segments of the requested content is transferred to the said user device;

user device is configured to carry out actions, wherein:

the said downloading pointer is received;

search is implemented for at least one source comprising at least one segment of the content according to the received downloading pointer, and communication session is initiated with the said at least one source, wherein requests are sent for the downloading of segments by way of sending the keys of the required segments, wherein in the process of the said requests processing the check of match is implemented of the keys sent in the request with the segment keys stored in the source device;

at least one content segment is received in case of successful communication session and keys match, otherwise the search step is repeated for at least one source device;

received segment key match check is implemented by way of key generation from the code information connected with the contents of the received segment and its comparison with the key sent in the request.

In a certain embodiment, if one or more content segments can not be received from the data transfer network from the source devices, the reception of the said content segments is implemented from the server.

In another particular embodiment the code information comprises the information connected with the segment contents and additional information. In another particular embodiment the additional information is the identified of the user device which the content is for.

In another particular embodiment the digital identifier comprised in the segment represents a digital watermark.

In another particular embodiment data transfer in the P2P and data transfer network is implemented in encrypted form, as well as content segments are stored on the devices in encrypted form.

In another particular embodiment information from the users devices is transferred to the server on the content segments which it stores and can send to the other users devices via P2P, as well as information which segments have been downloaded from the P2P and which from the server.

### BRIEF DESCRIPTION OF THE DRAWINGS

FIG. 1 shows the overall diagram of the media content distribution.

FIG. 2 shows overall steps of the content distribution method implementation.

FIG. 3 shows steps of the method implementation during creation of a unique copy of the content.

FIG. 4 shows an alteration of the content file copies creation.

FIG. 5 shows an example of the downloading pointer generation.

FIG. 6-FIG. 8 show alterations of the diagram of content segments exchange according to the claimed invention.

FIG. 9-FIG. 10 show an example of the segment key generation.

FIG. 11 shows the diagram of request and content segments downloading based on the keys reported in the downloading pointer.

FIG. 12 shows the diagram execution of implementation steps of the method for the segments transfer according to the claimed invention.

### DETAILED DESCRIPTION

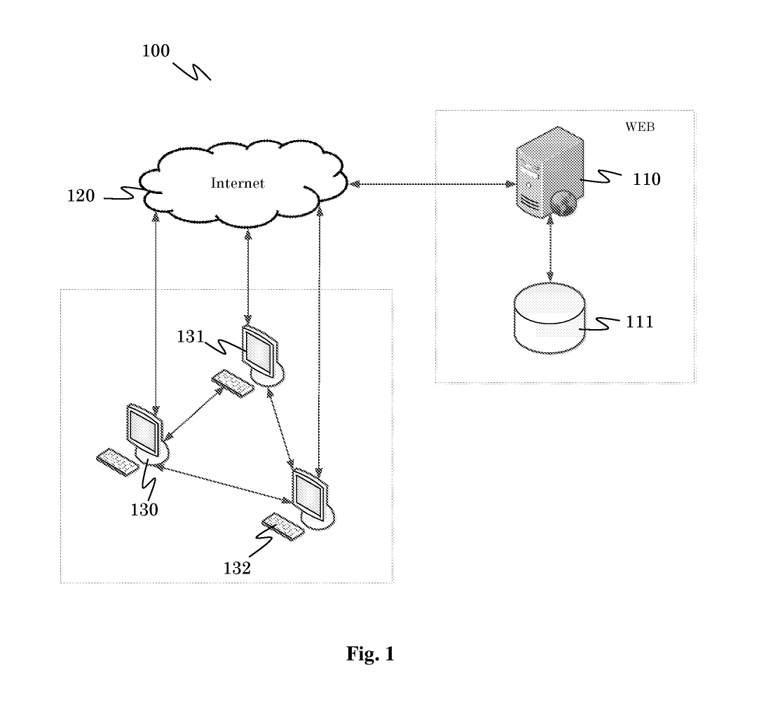

FIG. 1 shows overall view of the diagram of media content transfer according to the claimed invention. Claimed structure of the system 100 of media content transfer include a server of media content transfer 110 comprising media content storage 111. Server 110 can represent both single ECM and several computing devices (server cluster). Server 110 can also represent a supercomputer.

Media content storage 111 can represent a device for data storage (HDD, SSD, SD, Flash) directly being a part of the server 110, as well as it can be executed as a remote device for storage and transfer of information, for example, a personal computer, cloud information storage etc. conducting data exchange with the server 110 via data transfer channel (LAN, WLAN, WAN, GSM).

Hardware part of the server 110, generally, includes one or more processors, RAM, ROM, as well as devices for data storage (HDD, SSD, SD, Flash), input/output (I/0) interfaces and at least one network interface.

Server 110 with the help of data transfer network, for example, Internet, transfer the media content requested by the users 130-132. Users 130-132 can be connected with each other through data transfer network, for example, peer-to-peer (P2P).

The aforesaid in these application materials “content” or “media content” term relates both for the static type of content (movie, melody, audio book) and dynamic—streaming video, live TV or sports broadcasts, radio broadcasts etc.

Media content can represent any type of audiovisual production executed in the form of video file or audio file. Content can also represent files of container format (mkv, mp4, MOV, OGG etc.).

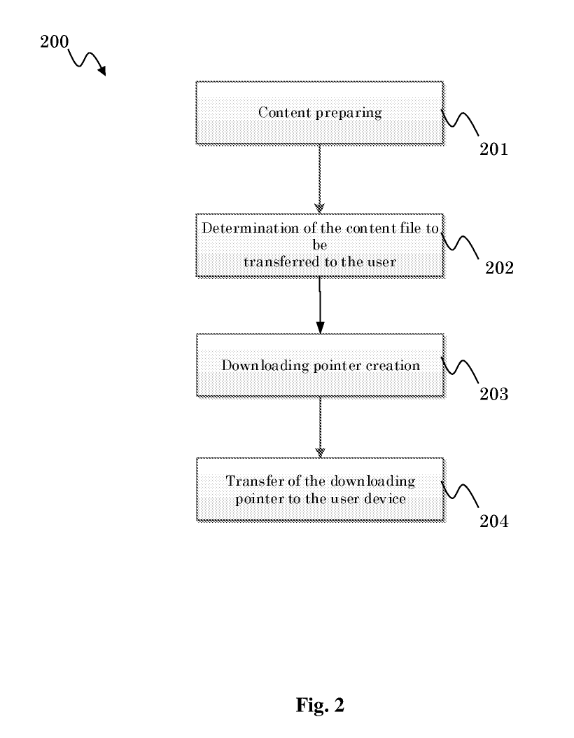

According to FIG. 2 the method 200 for media content transfer involves the following.

On the server 110 at the step 201 content preparation is implemented during which each source (master, original) file of the content is divided into segments. For each of the segments one or more copies are created which are further stored on the server and based on which the downloading pointer is further generated for the users requesting content.

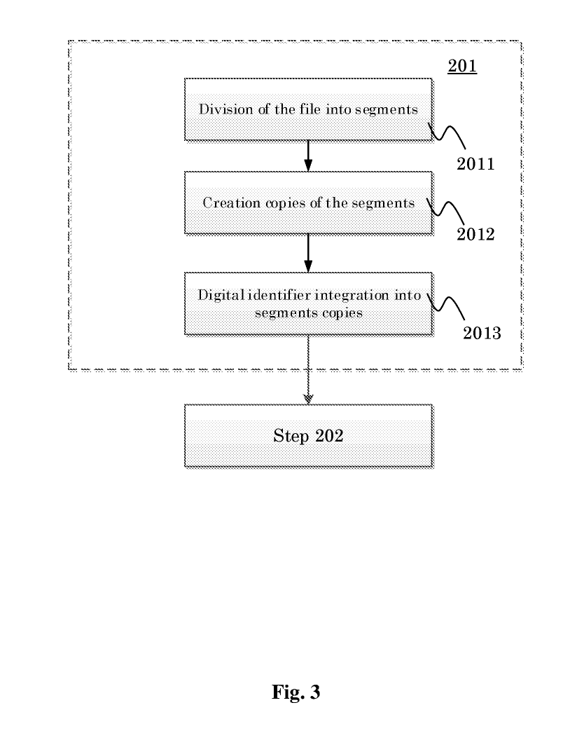

FIG. 3 shows decomposition of content preparation steps. At the step 2011 the source file of the content is divided into segments, at the step 2012 at least one copy of each segment is created, at the step 2013 digital identifier is integrated into each of the obtained segments. As a digital identifier can be understood, for example, a digital watermark or another type of identifier suitable for confirmation of the file uniqueness into which the identifier is integrated.

It should be noted that in the prior art there are widely known various principles of digital watermarks integrating in the content for its protection, both for static content (See, for example, RU 2405218, 27, Nov. 2010, U.S. Pat. No. 5,930,369 A, 10, Sep. 1997, patents), and dynamic (See, for example, Some Methods of Digital Watermarks Video Stream Integration. A. K. Grigoryan, N. G. Avetisova—Informatsionno-upravliaiushchie sistemy (Information and control systems).—No.2 (45). 2010).

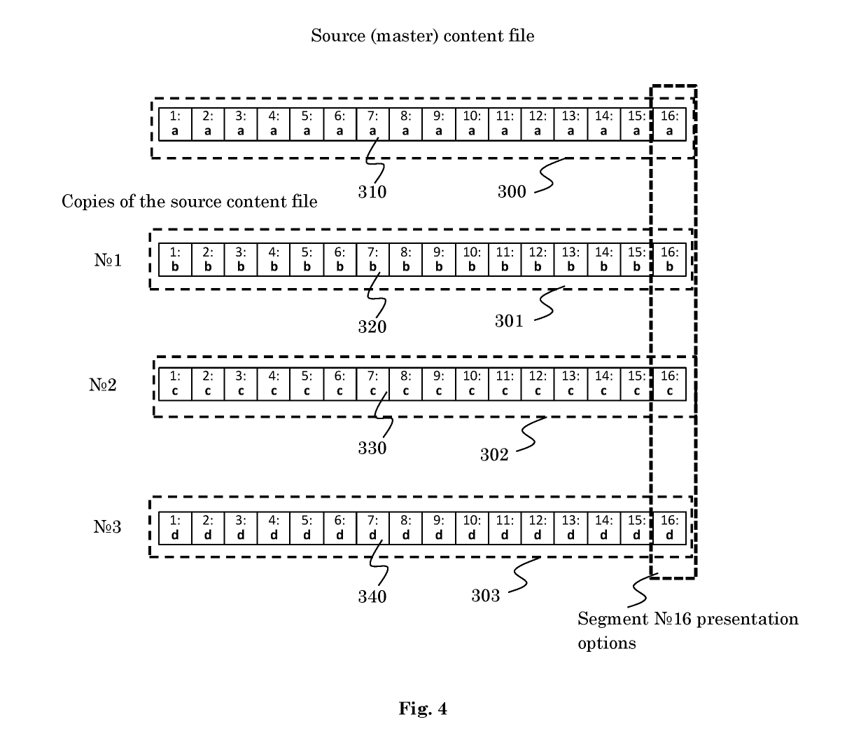

At the step 201 content preparation is implemented on the server 110. FIG. 4 shows an example of creation for the original file 300 of three copies 301-303, each of which comprises content 320-340 segments having a little different contents due to the fact that digital identifier (digital watermark) is integrated in them. Division of the original file into segments and creation of copies of the segments comprising digital identifier, is implemented by the server 110 in such a manner that composed of the obtained segments file, comprising for each segment serial number a random (any of available) alteration of presentation, preserves its integrity in the sense that it can be played without errors on the users devices. Thus, for each of the segments of the original file a set of alterations of its presentation a, b, c, d is created on the server. This set is used by the server during the process of the content downloading pointer creation wherein the server according to a specific rule chooses this or that segment presentation for each segment serial number. Rule, according to which the server chooses this or that presentation alteration for each segment, shall connect the client identifier and the generated sequence, as well as provide generation of unique sequence for each user (user device), which allows to use such sequence as an identifier of this user (user device).

At the step 202 users devices 130-132 execute the authorization process on the server 110 (or resource connected with the server 110) and send request to the server 110 for reception of media content. Server 110 accepts request from at least one user device (130-132) for provision of media content and determines the content requested by the user.

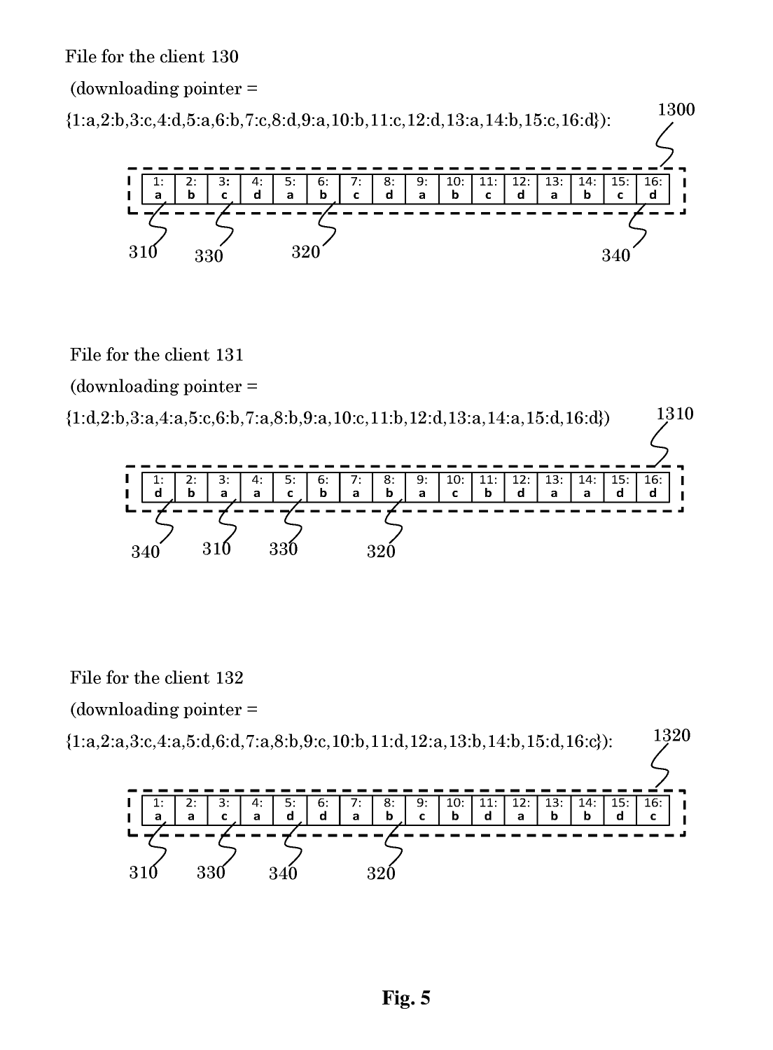

At the step 203 in response to the said determination the server 110 executes generation of requested content unique downloading pointer for each user device 130-132. Let us suppose that for client 131 the server stores the earlier issued identifier which is equal to d091270c (for brevity sake 4-byte numbers will be used), at the reception of request for content downloading the server 110 shall create a unique downloading pointer 1310 connected with the said user identifier. One of the alterations for creation of downloading pointer from the user identifier is the number conversion from one notation to another. According to FIG. 4 on the server 110 there are four alterations of presentation for each of the segments (source+three copies). I.e. it can be stated that the server 110 has available quaternary notation for presentations (alterations) of segments 310-340 in which the numbers are a, b, c, d characters which indicate the alterations of segments presentation. As the result, the server 110 can convert the d091270c hexadecimal number to dbaacbabacbdaadd quaternary number, thereafter based on this result create downloading pointer 1310connected with the device 131 and looking as a sequence {1:d,2:b,3:a,4:a,5:c,6:b,7:a,8:b,9:a,10:c,11:b,12:d,13:a,14:a,15:d,16:d} (FIG. 5).

Generation process of the downloading pointer connected with the client device 130-132 identifier can be implemented in some other manner including random generation of both client identifier and downloading pointer with subsequent saving of the obtained bond in the server 110 data base. That is why the said example is only a particular embodiment and in various embodiments of the method for content distribution other alterations of the client identifier (client device) bonding with the downloading pointer are possible.

FIG. 5 shows an example of downloading pointer 1300-1320 (step 203) creation according to the method 200 embodiment. Each pointer, for example, pointer 1300 for the client 130 represents a totality of segments 310-340 which can include both segments 310 without identifier (segments of the original content file) and segments 320-340 comprising identifier. Downloading pointer comprises links to the content segments in their sequence, wherein for each segment serial number this or that alteration of segment presentation is indicated.

At the step 204 transfer from server 110 is implemented of the corresponding downloading pointer 1300-1320 to each of the client devices 130-132 initiating the request for the reception of content.

Each of the devices 130-132, during the process of search for the content segments sources, can establish connection both with one device and with several simultaneously depending on the availability of the required segments on them.

Reception of the said segments can happen both via data transfer network, such as Internet, at the request for direct downloading of segments from the server 110, and via P2P from other users. The said client level relates to P2P, wherein user 130-132 devices implement exchange of content segments directly between each other. If any of the devices 130-132 can not receive content segments from the P2P, the said user device implements a request of the required content segments from the server side.

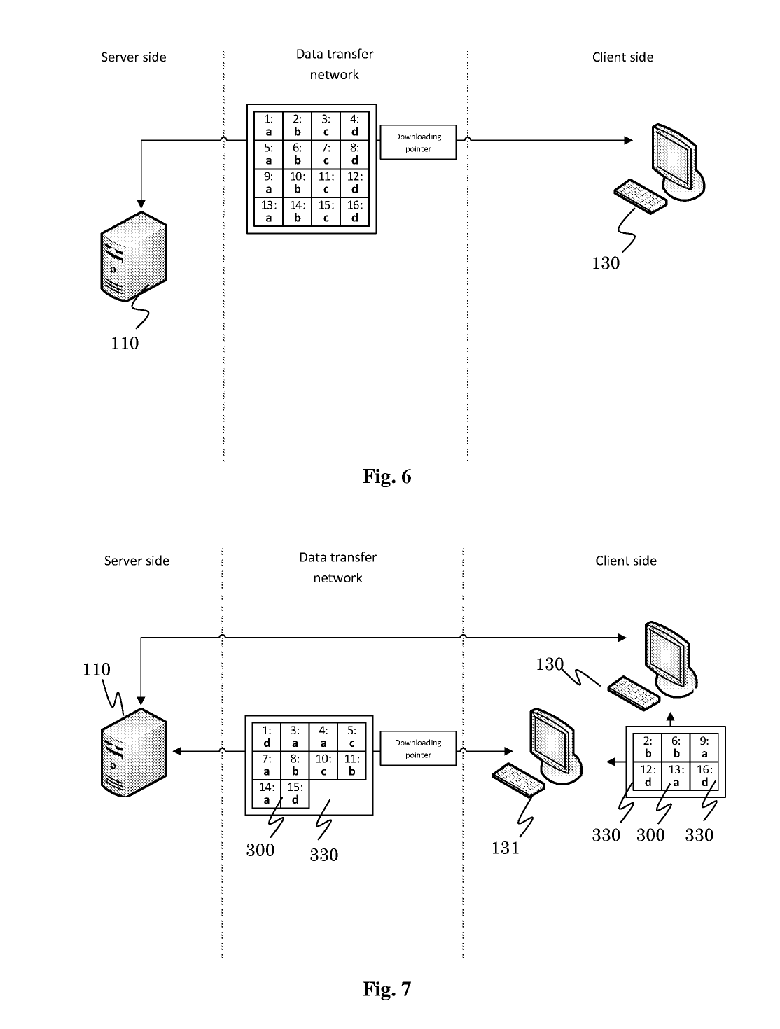

FIG. 6 shows an example where user device 130 implements reception of all content segments from the server 110 side. At first the server 110 transfers to the device 130 downloading pointer 1300 based on which the device 130 subsequently implements the request for the segments specified in the pointer in the data transfer network. Due to the fact that there is only one client 130 in the network and no other user device is detected, all content segments the client 130 downloads from the server 110.

Further, FIG. 7 shows an example of content transfer when beside client 130 client 131 appears in the network. Now client 131 receives its downloading pointer 1310 from the server 110 comprising unique sequence of content segments which is subject to transfer to the client 131. Further the server reports to the client 131 the source address comprising the required segments. In this case address of the client 130 is reported to the client 131, for example, ip address. Due to the fact that for clients 130 and 131 segments with serial numbers 2, 6, 9, 12, 13, 16 have, according to the downloading pointers 1300 and 1310, coinciding presentations, FIG. 7 shows that the device 131 receives segments with the said serial numbers from the device 130, while segments with other serial numbers the client 131 receives from the server 110.

Further, FIG. 8 shows an example of content transfer when beside clients 130 and 131 client 132 appears in the network. Now client 132 receives its downloading pointer 1320 from the server 110 comprising unique sequence of content segments which is subject to transfer to the client 132. Further the server reports to the client 132 the source addresses comprising the required segments. In this case address of the clients 130 and 131 are reported to the client 132, for example, ip addresses. Due to the fact that for clients 132 and 130 segments with serial numbers 1, 3, 10, 14, as well as for clients 132 and 131 segments with serial numbers 4, 7, 8, 15, have, according to the downloading pointers 1300, 1310 and 1320, coinciding presentations, FIG. 7 shows that the device 132 receives segments with serial numbers 1, 3, 10, 14 from the device 130, segments with serial numbers 4, 7, 8, 15 from the device 131, while segments with other serial numbers the client 132 receives from the server 110.

Each of the devices 130-132 periodically sends information to the server 110 on content segments, comprised in its memory, which it can transfer to other users via P2P. This information is used by the server 110 during certain time for sending to the users 130-132 devices in order to initiate the procedure of reception of the required segments in the P2P. Step of connection to the source of content segments reception by the users devices is implemented iteratively with the update of information on the devices addresses in the network, which comprise the required content segments. If connection to the device, comprising the content segments, fails to be established, the device requesting the reception of segments from other users devices can request the reception of the required segments from the server 110.

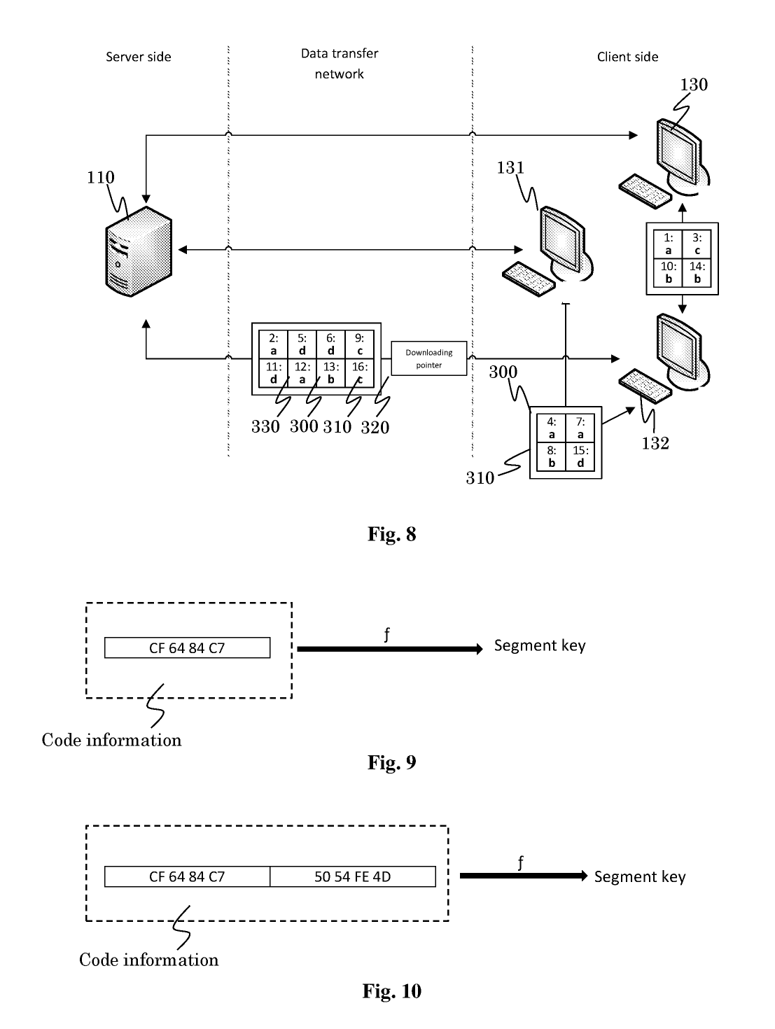

FIG. 9 and FIG. 10 show the segment key generation principle which is used in the downloading pointer. The downloading pointer comprises information on each segment of the content 310-340 in the form of segment key, which is used in case of request for segment downloading from the source (user device in P2P or server in the Internet). The segment key represents an identifier generated using f function from the code information. The used f function is irreversible, i.e. does not give the possibility to restore the code information (prototype) according to the known key (result). Additionally, the used f function shall be the same for all the network nodes and be known to all the network nodes. These properties are possessed by the cryptographic hash-functions (MD5, SHA 1 etc.), each of which, as well as their combination, can be used as the f function. Code information, in its turn, represents at least information connected to the segment contents (FIG. 9) or information connected with the segment contents and additional information (FIG. 10) which can be, for example, the identifier of the user device, to which the content is for, as well as any other service information, such as, for example, ip address of the source or user, region, token, time etc. Required property of the code information is that, along with f function, it shall be completely known to the network nodes participating in data exchange. In case of fulfilling of these conditions it becomes possible to generate the segment key both on the data source side and on the data receiver side, which, in its turn, allows to provide the keys matching check during sending and reception of each segment.

It is obvious that in case of key generation from the code information comprising only information connected to the segment contents (FIG. 9), the keys generated for different clients will be the same. While in case of key generation from the code information comprising not only information connected to the segment contents, but also additional information, for example, identifier of the client (client device) which the content is for (FIG. 10), the keys generated for different clients (clients devices) will be different.

Use of the keys generated from the code information connected with the segment contents (FIG. 9) provides the following advantages. Firstly, possibility to check the correctness of the key and segment matching both on the segment receiver side and on the segment sender side without addressing the server, and, on the sender side, send only the correct segment to the receiver, and, on the receiver side, to save and use only the correct segment. Secondly, possibility for the server to report to these or that users the keys that are unavailable in the P2P, thus switching the downloading for these users to the server completely (the required segments will never be present in the P2P) which can be useful for disconnection of user from the broadcast in case of detection of content leakage to the pirate channels of distribution in real time. Thirdly, complication of the computing of sequence, reported in the downloading pointer from the server, and substitution of the downloading pointer with another operable one, downloading attempts with which will be successful. Though, generally, infringer can connect several accounts, collect keys from all the downloading pointers received from the server, and construct of them a new downloading pointer which would comprise such segments sequence which the server will be unable to link to one or another client (client device).

Use of keys generated from the code information comprising not only information connected to the segment contents, but also additional information (FIG. 10), provides the following advantages. Firstly, impossibility of the computing of sequence, reported in the downloading pointer from the server, and substitution of the downloading pointer with another operable one, downloading attempts with which will be successful. Because even connecting hundreds of accounts the infringer for each account will receive new, not encountered before keys. As the result, it is statistically impossible to compute any pattern on the set of completely random keys. Secondly, impossibility to gain access to the segments, other than those the keys of which are reported by the server, due to the fact that only that device, for which the downloading pointer was generated and to whom it was sent, will be able to pass the checking of keys matching during request sending to the sources for downloading.

Thus it is possible to say that the claimed system, through the use of keys as the links to the segments and special rules of keys generation, comprises a conditional access mechanism wherein the server reports the content segments keys, while the user device can receive only and exclusively those content segments the keys of which were reported to it. It is senseless for the infringer to generate random keys or substitute keys intended for one device with keys intended for another device, because the network participants will not transfer the segments the keys of which failed to pass the check for matching.

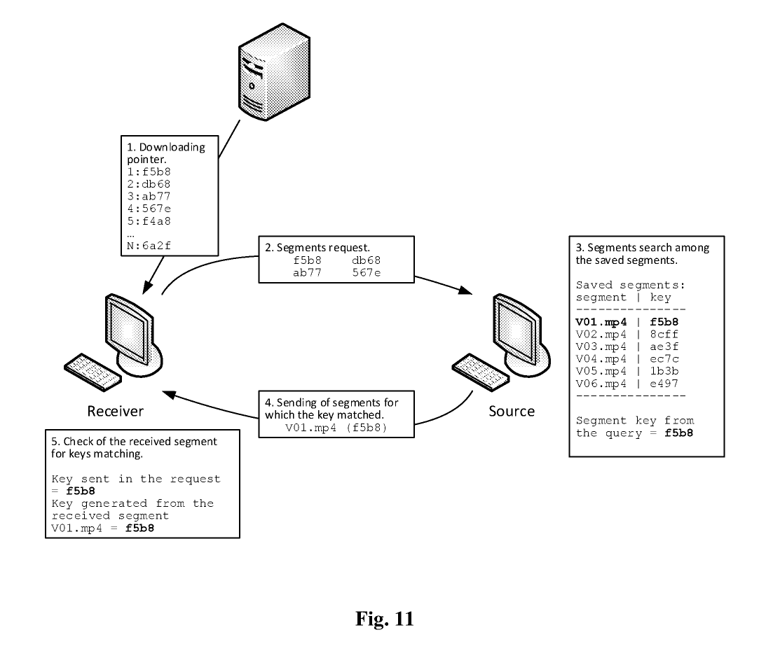

FIG. 11 shows the process of the segment request by the user by sending keys of four segments to the source, segment keys checking on the source device, transferring of one of segments for which the key matched, as well as final checking of the keys matching on the receiver device. Device receiving the segments downloads from the server 110 the downloading pointer and the list addresses of devices in the network, which comprise the required content segments. Receiver device establishes connection with the source device and requests segments which the source device can transfer according to information from the server. Segment request is implemented by way of transfer of at least one segment key from the receiver device to the source device. After reception of this request the source device implements search for segments for the keys received in the request. For this the source device generates keys for all the segments stored in its memory and, in case of keys matching, implements transfer of the segments corresponding to the matched keys to the receiver device. Similarly, the exchange of segments is implemented for any number of devices in the data transfer network and in P2P, between any pair of devices participating in the content segments exchange.

Data transfer in the P2P and data transfer network can be implemented in encrypted form. Additionally, content segments received by the devices can be stored in the devices in encrypted form.

After reception of segments the receiver device implements the procedure of the received segments checking by comparison of the segments keys sent in the request and keys generated from the code information connected to the received segments.

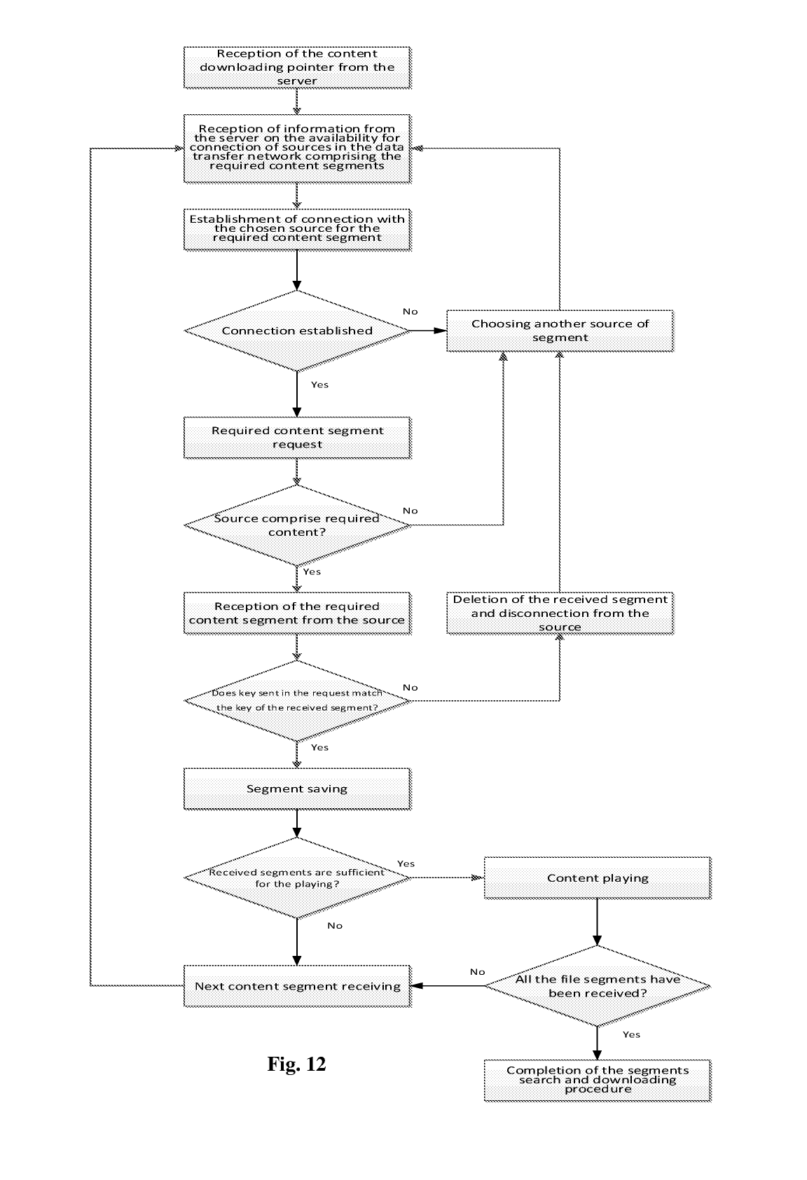

FIG. 12 shows the main algorithm of actions sequence during implementation of the method for content 200 distribution. After sending of downloading pointer to the chosen user device, the server also sends information on the addresses of the network users (IP-addresses, MAC addresses etc.) or addresses of servers which comprise the required segments of the content file in relation to the received downloading pointer by the said user device. This device establishes connection with or more external network users devices and implements request for content segments. The said request is fulfilled according to the mechanism shown in FIG. 11. After detection of content segments with matching keys, these segments are transferred to the user device that initiated the request. Upon reception of each segment, its validation is implemented by comparison of the segment key sent by the receiver device in the request with the key generated from the code information connected to the segment received from the source device. If the keys matching is confirmed, such segment is saved on the receiver device, otherwise the segment is not recognized valid and is deleted from the device memory. Additionally, information on such segment can be sent to the server for further processing in order to detect devices in the network which implement transfer of incorrect data.

After reception of the segment the system determines whether content playing is possible, for example, in case of content reception representing online video broadcast. If the content segments are insufficient, then the user device repeats the search for segments by establishing communication sessions with other users devices in the network. After start of the content playing the client device repeats the step of content segments request from the server. In particular, it is relevant for reception of dynamic content, for example, watching of a live translation of a sports game on a web site, as well as for reception of static content, for example, a movie with large size which would require significant time to download the entire file.

A situation can occur, when it is impossible to establish communication session with the device comprising the required content segment, in this case, if within the allotted interval of time the connection with such device is not established, than search for other devices is implemented which comprise the required segments. If user devices comprising the required segments are not detected, than the request is implemented for one or more segments from the server, wherein there can be several servers in the system and search for the necessary server can be implemented similarly to the search for the segments source devices (users).

The said in this application materials user device can represent various computing devices of portable or stationary type, for example, PC, smartphone, tablet, game console, laptop.

In general view, each of the client devices comprises at least one processor, at least one storage memory, in which the commands are stored to be executed by the processor which implement the execution of software application intended for the request for media content from the server, its reception and exchange with other participants of the P2P.

The description presented in this application discloses the preferred embodiments of the claimed invention and shall not be considered as limiting other particular embodiments of the claimed solution, which are not outside the framework of the ones presented in this application.

1. Method for distribution of media content in the data transfer network, wherein:
on the server side:
dividing the source file of the content into segments, wherein a serial number is assigned to each segment;
creating a set of possible presentations for each of the segments by way of creation of at least one copy of each segment, and integrating of a digital identifier into each of the copies;
receiving a request from the user device for the content provision;
creating, in response to the said request of the user device content, the downloading pointer, which comprises information on the content segments which are subject to provision to the said user device, wherein for each segment serial number one of this segment presentation alterations is chosen, wherein the downloading pointer comprises information on each content segment in the form of the segment key, such that the segment key is a function of the code information, comprising at least the information connected with the segment contents;
transferring the said downloading pointer to the user device;
transferring the information on the addresses of the sources, comprising segments of the requested content, to the said user device;
on the user device side:
receiving the said downloading pointer;
implementing a search for at least one source comprising at least one segment of the content according to the received downloading pointer, and initiating communication session with the said at least one source, wherein requests are sent for the downloading of segments by way of sending the keys of the required segments, wherein in the process of the said requests processing the check of match is implemented of the keys sent in the request with the segment keys stored in the source device;
receiving at least one content segment in case of successful communication session and keys match, otherwise the search step is repeated for at least one source device;
implementing received segment key match check by way of key generation from the code information connected with the contents of the received segment and its comparison with the key sent in the request.

2. Method according to claim 1, wherein if one or more content segments can not be received from the data transfer network from the source devices, the reception of the said content segments is implemented from the server with conduction of segment keys check.

3. Method according to claim 1, wherein the code information includes the information connected with the segment contents and additional information.

4. Method according to claim 3, wherein the additional information is the identifier of the user device which the content is for.

5. Method according to claim 1, wherein the digital identifier comprised in the segment represents a digital watermark.

6. Method according to claim 1, wherein the user devices are connected using P2P data transfer network.

7. Method according to claim 6, wherein data transfer is implemented in encrypted form, as well content segments storage on the devices is implemented in encrypted form.

8. Method according to claim 1, wherein information from the users devices is transferred to the server on the content segments which it stores and can send to the other users devices via P2P, as well as information which segments have been downloaded from the P2P and which from the server.

9. System of media content distribution in the data transfer network comprising at least one server and many users devices, wherein the server is configured to execute operations, wherein:
dividing the source file of the content into segments, wherein a serial number is assigned to each segment;
creating a set of possible presentations for each of the segments by way of creation of at least one copy of each segment, and integrating of a digital identifier into each of the copies;
receiving a request from the user device for the content provision;
creating, in response to the said request of the user device content, the downloading pointer, which comprises information on the content segments which are subject to provision to the said user device, wherein for each segment serial number one of this segment presentation alterations is chosen, wherein the downloading pointer comprises information on each content segment in the form of the segment key, such that the segment key is a function of the code information, comprising at least the information connected with the segment contents;
transferring the said downloading pointer to the user device;
transferring the information on the addresses of the sources, comprising segments of the requested content, to the said user device;
user device is configured to carry out actions, wherein:
receiving the said downloading pointer;
implementing a search for at least one source comprising at least one segment of the content according to the received downloading pointer, and initiating communication session with the said at least one source, wherein requests are sent for the downloading of segments by way of sending the keys of the required segments, wherein in the process of the said requests processing the check of match is implemented of the keys sent in the request with the segment keys stored in the source device;
receiving at least one content segment in case of successful communication session and keys match, otherwise the search step is repeated for at least one source device;
implementing received segment key match check by way of key generation from the code information connected with the contents of the received segment and its comparison with the key sent in the request.

10. System according to claim 9, wherein if one or more content segments can not be received from the data transfer network from the source devices, the reception of the said content segments is implemented from the server with conduction of segment keys check.

11. System according to claim 9, wherein the code information includes the information connected with the segment contents and additional information.

12. System according to claim 11, wherein the additional information is the identifier of the user device which the content is for.

13. System according to claim 9, wherein the digital identifier of the segment represents a digital watermark.

14. System according to claim 9, wherein the user devices are connected with each other using P2P data transfer network.

15. System according to claim 14, wherein data transfer is implemented in encrypted form, as well content segments storage on the devices is implemented in encrypted form.

16. System according to claim 9, wherein information from the users devices is transferred to the server on the content segments which it stores and can send to the other users devices via P2P, as well as information which segments have been downloaded from the P2P and which from the server.
